(19) United States
(12) Patent Application Publication
(10) Pub. No.: US 2022/0378654 A1
(43) Pub. Date: Dec. 1, 2022

(54) EAR ACUPRESSURE ASSEMBLY

(71) Applicant: CM, LLC, Fort Myers, FL (US)

(72) Inventor: Vincent Cimato, Fort Myers, FL (US)

(73) Assignee: CM, LLC, Fort Myers, FL (US)

(21) Appl. No.: 17/332,134

(22) Filed: May 27, 2021

(51) Int. Cl. A61H 39/04

(52) U.S. Cl. CPC A61H 39/04; A61H 2201/0153; A61H 2201/0157; A61H 2201/1607; A61H 2201/165; A61H 2205/027; A61H 2201/1695

(57) ABSTRACT

An acupressure assembly having a handheld and portable headband member with two opposing headband ends and a plurality of ear housings pivotably coupled thereto and also with a sidewall enclosing a housing cavity, a spring member disposed within the housing cavity, a housing cover coupled to the sidewall and defining a plurality of pin apertures spanning through the cover. A deformable cushion member is coupled to the cover and is designed to surround a user's ear. A plurality of acupressure pins are retained by the cover, are directly coupled to the spring member, have a rounded pressure surface, and are each selectively and linearly translatable along a pin length within the plurality of pin apertures, wherein the spring member is operably configured to bias the plurality of acupressure pins outwardly away from the front surface of the cover to apply pressure to the inside of a user's ear.

### FIELD OF THE INVENTION

The present invention relates generally to devices configured to apply localized pressure to a user, and, more particularly, relates to a device operably configured to apply localized pressure to a user's ears.

### BACKGROUND OF THE INVENTION

Acupressure is generally thought of as an alternative medicinal technique often used in conjunction with acupuncture. Many users experience pain-relieving and stress-relieving effects from using acupressure techniques. Acupressure is also generally based on the concept of applying physical pressure to acupuncture points or trigger points on a user's body. Pressure may be applied by hand, by elbow, or with various devices. Many of these acupuncture points or trigger points are found on a user's (human or animal) ear, which are often difficult or impossible to reach without special tools. Some medical studies have suggested that acupressure may be effective at helping manage nausea and vomiting, low back pain, tension headaches, stomachache, among other things.

Most known devices aimed at applying pressure or other stimulation to a user's ears utilize electrical or pneumatic means to do so. As such, these devices are costly and prone to failure because of the many parts required to operate them. Further, these devices also require a power source that many users find undesirable. Further, those known devices that utilize an electrical or pneumatic means only emulate the effects of acupressure and often fall short of providing users with a satisfying and/or effective treatment. Some other known devices aimed at applying pressure to a user's ears utilize one or more rigid pressure applicators that lack mobility and fail to effectively apply simultaneous and/or localized pressure to the many areas of the user's ear where pressure needed.

Therefore, a need exists to overcome the problems with the prior art as discussed above.

### SUMMARY OF THE INVENTION

The invention provides an ear acupressure assembly that overcomes the hereinafore-mentioned disadvantages of the heretofore-known devices and methods of this general type and that is configured to apply pressure to multiple surfaces of a user's ears, simulating an acupuncture effect thereon. The device includes two opposing ear coupling bodies, each having a cushion portion operably configured to surround a user's ear and apply pressure thereon and at least one of a plurality of pins or a plurality of spheres (collectively referred to as pins for brevity unless expressly stated). The pins are translatably coupled to a spring-like device (e.g., a spring, sponge, air, gel, water, etc.) that biases the distal end of the plurality of pins outwardly from the cushion, such that when a user places the device over a user's ears, the pins or spheres apply pressure to multiple surfaces of the user's ears.

With the foregoing and other objects in view, there is provided, in accordance with the invention, an ear acupressure assembly having a handheld and portable headband member with two opposing headband ends, a headband length separating the headband ends, and a plurality of ear housings pivotably coupled to the headband member along the headband length. Each of the ear housings have a sidewall enclosing a housing cavity, a spring member disposed within the housing cavity, a housing cover coupled to the sidewall to encapsulate the spring member within the housing cavity, with a front surface, with a rear surface opposing the front surface, with cover thickness separating the front and rear surfaces of the housing cover, defining a plurality of pin apertures spanning the cover thickness, and a plurality of acupressure pins retained by the housing cover. Each of the plurality of acupressure pins may be of an elongated shape, may each have a first pin end directly coupled to the spring member, may each have a second pin end opposing the first pin end and having a rounded pressure surface disposed thereon, may each have a pin length separating the first and second pin ends, and may each be selectively and linearly translatable along the pin length within one of the plurality of pin apertures, wherein the spring member is operably configured to bias the plurality of acupressure pins in a longitudinal direction outwardly away from the front surface of the housing cover.

In accordance with another feature, an embodiment of the present invention includes the sidewall having an inner surface defining the housing cavity with a housing volume, the spring member defining a spring volume substantially equal to the housing volume.

In accordance with a further feature of the present invention, the spring member is of a polymeric foam material.

In accordance with yet another feature, an embodiment of the present invention also includes the sidewall having an inner surface defining the housing cavity, wherein the spring member is directly coupled and retained to the inner surface of the sidewall, wherein the spring member may be also of a polymeric foam material.

In accordance with an additional feature of the present invention, the plurality of ear housings are each respectively disposed proximal to the two opposing headband ends.

In accordance with a further feature, an embodiment of the present invention also includes the sidewall having a perimeter sidewall surface disposed proximal to the distal terminal end of the sidewall and surrounding the sidewall, wherein the perimeter sidewall surface frictionally and compressively coupled by the housing cover.

In accordance with yet another feature, an embodiment of the present invention also includes an outer pin length separating the second pin end and the front surface of the housing cover, wherein the plurality of acupressure pins are operably configured to translate along a linear pin translation path within the one of the plurality of pin apertures to selectively adjust the outer pin length.

In accordance with an additional feature, an embodiment of the present invention also includes a deformable cushion member coupled to the front surface of the housing cover, surrounding the plurality of acupressure pins, and with a perimeter cushion surface, wherein the second pin end of each of the plurality of acupressure pins are operably configured to be interposed between the perimeter cushion surface and the front surface.

In accordance with a further feature, an embodiment of the present invention also includes each of the plurality of acupressure pins having a flange member disposed proximal to the first pin end thereon and extending radially outward from an outer pin surface thereon.

In accordance with an additional feature of the present invention, each of the plurality of pin apertures define a pin aperture diameter and each of the flange members define a flange diameter greater than the pin aperture diameter.

In accordance with an exemplary feature, an embodiment of the present invention also includes the front surface of the housing cover having a front cover area defined by an outer perimeter edge of the housing cover, wherein the plurality of acupressure pins occupy at least 50% of the front cover area and are disposed in a tightly spaced configuration.

In accordance with the present invention, an ear acupressure assembly includes a handheld and portable headband member with two opposing headband ends, a headband length separating the headband ends, a deformable cushion member, and a plurality of ear housings pivotably coupled to the headband member along the headband length and each having a sidewall enclosing a housing cavity, a spring member disposed within the housing cavity, a housing cover coupled to the sidewall to encapsulate the spring member within the housing cavity, with a front surface with the deformable cushion member coupled thereto, with a rear surface opposing the front surface, with cover thickness separating the front and rear surfaces of the housing cover, defining a plurality of pin apertures spanning the cover thickness, and a plurality of acupressure pins retained by the housing cover, each with a first pin end operably coupled to the spring member, each with a second pin end opposing the first pin end and having a rounded pressure surface disposed thereon, each with a pin length separating the first and second pin ends, each with an outer pin length separating the second pin end and the front surface of the housing cover, and each operably configured to translate along a linear pin translation path within the one of the plurality of pin apertures to selectively adjust the outer pin length. The spring member is also operably configured to bias the plurality of acupressure pins in a longitudinal direction outwardly away from the front surface of the housing cover and the deformable cushion member surrounding the plurality of acupressure pins, and with a perimeter cushion surface, wherein the second pin end of each of the plurality of acupressure pins is operably configured to be interposed between the perimeter cushion surface and the front surface of the housing cover.

Although the invention is illustrated and described herein as embodied in an ear acupressure assembly, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the pins and/or movement of the pins.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of an ear acupressure assembly in accordance with one embodiment of the present invention;

FIG. 2 is a cross-sectional view of the ear acupressure assembly depicted in FIG. 1 along section line 1-1;

FIG. 3 is an exploded view of the ear acupressure assembly depicted in FIG. 1;

FIG. 4 is a fragmentary close-up view of an ear acupressure assembly coupled to a user's ear in an overlapping configuration in accordance with one embodiment of the present invention;

FIGS. 5-6 depict perspective and elevational views, respective, of an acupressure pin utilized with the ear acupressure assembly in accordance with one embodiment of the present invention;

FIG. 7 depicts a perspective view of an ear acupressure assembly coupled to the ears of a user in an overlapping configuration in accordance with one embodiment of the present invention; and

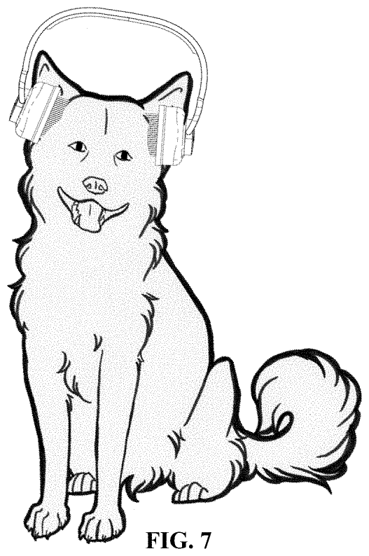

FIG. 8 is a fragmentary close-up view of an ear acupressure assembly having a cushion member in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

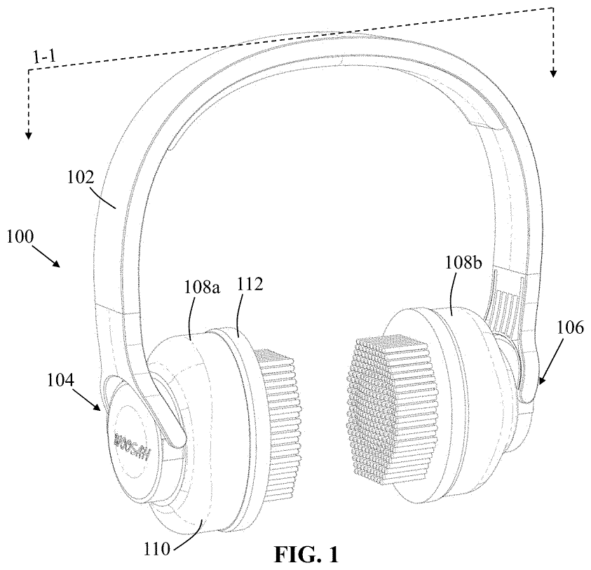

The present invention provides a novel and efficient ear acupressure assembly that applies pressure to a user's ear in a safe, effective, efficient, and relatively inexpensive manner. Specifically, referring now to FIG. 1, one embodiment of the present invention is shown in a perspective view. FIG. 1, along with the other figures, show several advantageous features of the present invention, but, as will be described below, the invention can be provided in several shapes, sizes, combinations of features and components, and varying numbers and functions of the components. The first example of an ear acupressure assembly 100, as shown in FIG. 1, includes a handheld and portable headband member 102 with two opposing headband ends 104, 106, a headband length separating the headband ends 104, 106, and a plurality of ear housings 108a-b pivotably coupled to the headband member 102 along the headband length.

Said another way, the headband member 102 may is configured to surround a portion of a user's head and couple with ear housings 108a-b that may be configured to rotate or pivot in order to comfortably adjust the housings 108a-b relative to the user's head, namely the ears on a user's head. The headband length may be selectively adjusted to accommodate larger or small head circumferences. The headband member 102 may also beneficially include a deformable material thereon, e.g., neoprene, for providing a comfortable fit with a user's head. The headband member 102 is portable and handheld in that it is able to be carried and transported by a user with a single hand and is generally lightweight, e.g., less than approximately 5 lbs.

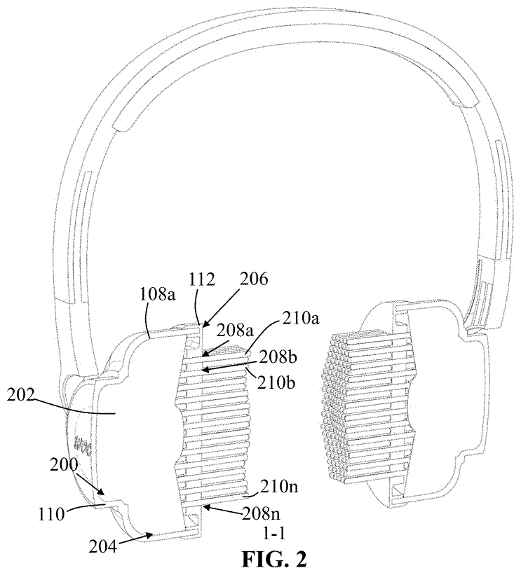

With reference to FIGS. 1-2, the housings 108a-b are preferably located at the distal terminal end of the headband member 102 and may be of a substantially rigid and durable material, e.g., a polymeric material such as polyester or polycarbonate. Each of the housings 108a-n also each include a sidewall 110 enclosing a housing cavity 200. As used herein, the term “wall” is intended broadly to encompass continuous structures, as well as, separate structures that are coupled together so as to form a substantially continuous external surface. The housings 108a-b may be casted, or injection molded, but are preferably of an integral material and may include one or more apertures or recesses for receiving and coupling with the headband member 102 (as exemplified in FIG. 1).

The housings 108a-b also beneficially include a spring member 202 disposed within the housing cavity 200, wherein the spring member 202 may be a wire or plate-like spring, sponge, pressurized air, a dense liquid material such as gel, a diaphragm, etc. In one embodiment, an inner surface 204 defining the housing cavity 200 also defines a housing volume, wherein the spring member 202 defines a spring volume substantially equal (within +/−5% variance) to the housing volume. In said embodiment, the spring member 202 is beneficially of a polymeric foam material. Said another way, the polymeric foam material is deformably and/or elastically resilient. Further, the polymeric foam material may be of a polyethylene or silicone material. The spring material may be preferably and beneficially of a closed-cell material that is otherwise free of any apertures thereon that would cause the acupressure pins 210a-n (wherein “n” represents any number greater than two) used to apply pressure to a user's ears to penetrate the spring material upon experiencing forces thereon ranging from 1-10 lbf. Said differently, when the user places the housings 108a-n in an overlapping configuration with the user's ears, the force generated back on the spring member 202 from the user's ears will not cause the acupressure pins 210a-n to puncture therethrough or otherwise cause plastic deformation thereon.

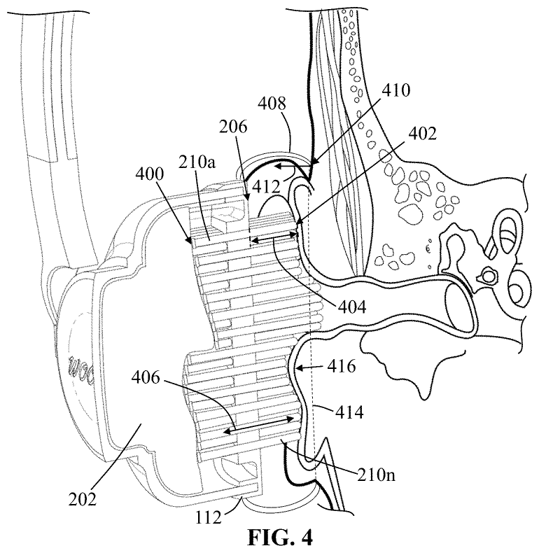

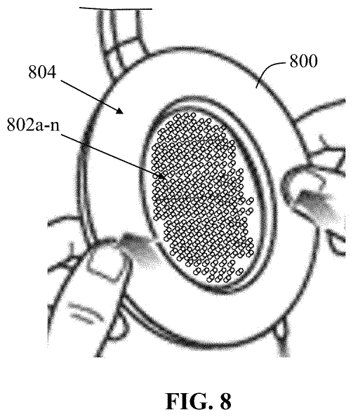

In one embodiment, the inner surface 204 defining the housing cavity 200 and the spring member 202 are directly coupled together, e.g., the spring member 202 is retained to the inner surface 204 of the sidewall 110 using just friction caused by the deformation of the spring material, e.g., a polymeric foam material. In some embodiments, fasteners or adhesive may be utilized to adhere or otherwise directly the spring member 202 to the inner surface 204, thereby providing a stronger coupling configuration between the spring member 202 and the housing retaining the spring member 202. In one embodiment, the spring member 202 may be of a metallic material that spans across from opposing sides of the inner surface 204 of the sidewall 110, wherein each of the acupressure pins 210a-n are directly coupled thereto. As such, when a force is applied to the spring member 202, it causes an equal and opposite force that is applied to the user's ear, i.e., biasing the one or more acupressure pin(s) 210a-n toward the user's ear and applying a pressure thereon that provides therapeutic and/or stress relieve for a user. The use of a deformable cushion member 408, 800 (as best seen in FIG. 4 and FIG. 8) also provides an opposite force (depicted with arrow 412) that enables a comfortable fit to the user and stabilizes the localized pressure provided by the pins 210a-n.

With reference to FIGS. 1-3, a housing cover 112 can be seen beneficially coupled to the sidewall 110 to encapsulate the spring member 202 within the housing cavity 200, thereby reducing the likelihood of failure to the spring member 202 or pins 210a-n. The housing cover 112 includes a front surface 206, a rear surface 300 opposing the front surface 206, a cover thickness separating the front and rear surfaces 206, 300 of the housing cover 112, and defines a plurality of pin apertures 208a-n spanning the cover thickness (which may be approximately 10-20 mm). The diameter of each of the pin apertures 208 will be slightly larger than a diameter of the pins 210a-n, e.g., approximately 4-15 mm.

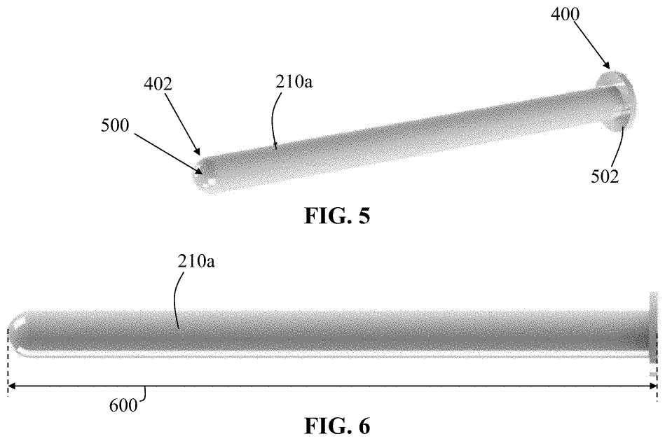

With reference to FIGS. 4-6, the plurality of acupressure pins 210a-n are retained by the housing cover 112 and may each be of an elongated shape (as depicted in the figures) enabling effective utilization of multiple pins 210a-n to apply to pressure to the numerous pressure points within a user's ears. Each of the plurality of acupressure pins 210a-n include a first pin end 400 that is coupled to the spring member 202 and a second pin end 402, opposing the first pin end 400, that has a rounded pressure surface 500 disposed thereon. Said another way, the second pin end 402 is not sharp or to a point that would cause penetration of a user's skin under the forces described herein. Close-up views of the plurality of acupressure pins 210a-n, including the rounded pressure surface 500, can be seen in FIGS. 5-6. Each of the plurality of acupressure pins 210a-n include a pin length 600 separating the first and second pin ends 400, 402 and are each operable to be selectively, independently, and linearly translatable along the pin length 600 within one of the plurality of pin apertures 208a-n. In one embodiment, the pin length 300 is approximately 10-60 mm to effectively cause pressure to the user's ear after utilizing the deformable cushion member 408, but may vary outside of said range.

As seen best in FIG. 4, each of the plurality of acupressure pins 210a-n include an outer pin length 404 separating the second pin end 402 and the front surface 206 of the housing cover 112. Each of the plurality of acupressure pins 210a-n may also be operably configured to translate along a linear pin translation path (exemplified with arrow 406) within the one of the plurality of pin apertures 208a-n to selectively adjust the outer pin length 404. As discussed above, the plurality of acupressure pins 210a-n may have a static configuration (i.e., when the assembly 100 not applied to the user's ears in an overlapping configuration) with a portion of the outer pin length 404 (e.g., 10-15 mm) that extends beyond the perimeter cushion surface 410 of the deformable cushion member 408. When the plurality of acupressure pins 210a-n are placed in a dynamic or active configuration (i.e., when the assembly 100 is applied to the user's ears in an overlapping configuration and pressure is applied to the user's ears) the portion of the outer pin length 404 is then retracted to a position before the perimeter cushion surface 410 (see fantom line 414) of the deformable cushion member 408 or within a cushion cavity 416 (as depicted in FIG. 4).

With reference to FIG. 4 and FIG. 8, when the assembly 100 beneficially utilizes the deformable cushion member 408, 800, it is coupled to the front surface 206 of the housing cover 112, surrounds the plurality of acupressure pins 210a-n, 802a-n, and has the perimeter cushion surface 410 that may be of a foam and/or polymeric/cloth material (as is known in the art). The second pin end 402 of each of the plurality of acupressure pins 210a-n is operably configured to be interposed between the perimeter cushion surface 804 and the front surface 206. As seen in the figures and discussed herein, the spring member 202 is operably configured to bias the plurality of acupressure pins 210a-n in a longitudinal direction outwardly away from the front surface 206 of the housing cover 112. As such and as seen in the figures, there are generally no electronics utilized in the assembly 100 and pressure applied to the skin within the user's ears is achieved by the plurality of acupressure pins 210a-n. Said another way, the assembly 100 applies pressure inward towards the skin of the user's ear and the cushion 800 attached to the assembly 100 relieves the pressure away from the user's ear, thereby providing effective, safe, and comfortable acupressure on the user's ear.

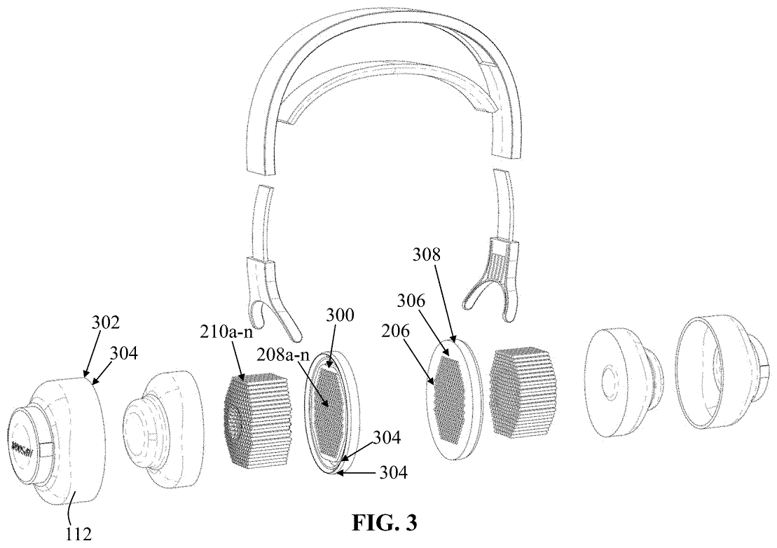

In one embodiment, the plurality of ear housings 108a-b are each respectively disposed proximal to (i.e., at or near, within 10% of the length of the corresponding structure) the two opposing headband ends 104, 106. To enable effective coupling and assembly, the sidewall 110 may also include a perimeter sidewall surface 302 disposed proximal to the distal terminal end 304 of the sidewall 110 and surrounding the sidewall 110, the perimeter sidewall surface 302 frictionally and compressively coupled by the housing cover 300. Said another way, the sidewall 110 and housing cover 300 may be shaped, sized, and configured to directly and frictionally couple with one another. In some embodiments, one or more fastener(s) may be utilized to retain the sidewall 100 and housing cover 300 together. Further, the sidewall 110 and housing cover 300 may also be configured to allow selective coupling and decoupling by applying a sufficient tensile force on the housing cover 300 away from the distal terminal end 304 of the sidewall 100. As best seen in FIG. 3, the housing cover 112 may include a double walled structure 304 that defines a cover channel 306 spanning around a perimeter of the housing cover 112, wherein the cover channel 305 is shaped and sized to receive and retain (compressively and frictionally) the perimeter sidewall surface 302.

With reference to FIGS. 2-6, each of the plurality of acupressure pins 210a-n also include a flange member 502 disposed proximal to the first pin end 400 thereon and extending radially outward from an outer pin surface 504 thereon, thereby providing preventing the plurality of acupressure pins 210a-n from being removed from the housing cover 300 from the biasing force caused by the spring member 202. Further, each of the plurality of pin apertures 208a-n define a pin aperture diameter (as described above) and each of the flange members 502 define a flange diameter greater than the pin aperture diameter. In one embodiment, the first pin end 400 is structurally unattached or directly uncoupled to the spring member 202 to allow more independent translation of the plurality of acupressure pins 210a-n. In other embodiments, the first pin ends 400 may be coupled to the spring member 202 with adhesive, mechanically coupled with one or more fasteners, and/or welded.

The front surface 206 of the housing cover 112 can be seen defining a front cover area 306 defined by an outer perimeter edge 308 of the housing cover 112, wherein the plurality of acupressure pins 210a-n occupy at least 50% of the front cover area 306 and are disposed in a tightly spaced configuration. In preferred embodiments, the plurality of acupressure pins 210a-n occupy at least 75-90% percent of the front cover area 306 to ensure localized pressure is sufficiently distributed around the user's ear. The plurality of acupressure pins 210a-n are tightly spaced in that they are no greater than approximately 10 mm from one another. In preferred embodiments, the plurality of acupressure pins 210a-n are equally spaced from one another on the front cover area 306 to ensure localized pressure is sufficiently distributed around the user's ear. Preferably, there are greater than approximately 25 acupressure pins 210a-n to ensure localized pressure is sufficiently distributed around the user's ear.

Although a specific order of executing the process steps has been described and depicted, the order of executing the steps may be changed relative to the order shown in certain embodiments. Also, two or more steps shown or described as occurring in succession may be executed concurrently or with partial concurrence in some embodiments. Certain steps may also be omitted in for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. An ear acupressure assembly comprising:
a handheld and portable headband member with two opposing headband ends, a headband length separating the headband ends, and a plurality of ear housings pivotably coupled to the headband member along the headband length and each having:
a sidewall enclosing a housing cavity;
a spring member disposed within the housing cavity;
a housing cover coupled to the sidewall to encapsulate the spring member within the housing cavity, with a front surface, with a rear surface opposing the front surface, with cover thickness separating the front and rear surfaces of the housing cover, defining a plurality of pin apertures spanning the cover thickness; and
a plurality of acupressure pins retained by the housing cover, each of an elongated shape, each with a first pin end directly coupled to the spring member, each with a second pin end opposing the first pin end and having a rounded pressure surface disposed thereon, each with a pin length separating the first and second pin ends, and each selectively and linearly translatable along the pin length within one of the plurality of pin apertures, the spring member operably configured to bias the plurality of acupressure pins in a longitudinal direction outwardly away from the front surface of the housing cover.

2. The ear acupressure assembly according to claim 1, wherein the sidewall further comprises:
an inner surface defining the housing cavity with a housing volume, the spring member defining a spring volume substantially equal to the housing volume.

3. The ear acupressure assembly according to claim 2, wherein:
the spring member is of a polymeric foam material.

4. The ear acupressure assembly according to claim 1, wherein the sidewall further comprises:
an inner surface defining the housing cavity, the spring member directly coupled and retained to the inner surface of the sidewall, the spring member of a polymeric foam material.

5. The ear acupressure assembly according to claim 1, wherein:
the plurality of ear housings are each respectively disposed proximal to the two opposing headband ends.

6. The ear acupressure assembly according to claim 1, wherein the sidewall further comprises:
a perimeter sidewall surface disposed proximal to the distal terminal end of the sidewall and surrounding the sidewall, the perimeter sidewall surface frictionally and compressively coupled by the housing cover.

7. The ear acupressure assembly according to claim 1, further comprising:
an outer pin length separating the second pin end and the front surface of the housing cover, the plurality of acupressure pins operably configured to translate along a linear pin translation path within the one of the plurality of pin apertures to selectively adjust the outer pin length.

8. The ear acupressure assembly according to claim 7, further comprising:
a deformable cushion member coupled to the front surface of the housing cover, surrounding the plurality of acupressure pins, and with a perimeter cushion surface, the second pin end of each of the plurality of acupressure pins operably configured to be interposed between the perimeter cushion surface and the front surface.

9. The ear acupressure assembly according to claim 1, wherein each of the plurality of acupressure pins further comprise:
a flange member disposed proximal to the first pin end thereon and extending radially outward from an outer pin surface thereon.

10. The ear acupressure assembly according to claim 9, wherein:
each of the plurality of pin apertures define a pin aperture diameter and each of the flange members define a flange diameter greater than the pin aperture diameter.

11. The ear acupressure assembly according to claim 1, wherein the front surface of the housing cover further comprises:
a front cover area defined by an outer perimeter edge of the housing cover, wherein the plurality of acupressure pins occupy at least 50% of the front cover area and are disposed in a tightly spaced configuration.

12. An ear acupressure assembly comprising:
a handheld and portable headband member with two opposing headband ends, a headband length separating the headband ends, a deformable cushion member, and a plurality of ear housings pivotably coupled to the headband member along the headband length and each having:
a sidewall enclosing a housing cavity;
a spring member disposed within the housing cavity;
a housing cover coupled to the sidewall to encapsulate the spring member within the housing cavity, with a front surface with the deformable cushion member coupled thereto, with a rear surface opposing the front surface, with cover thickness separating the front and rear surfaces of the housing cover, defining a plurality of pin apertures spanning the cover thickness; and
a plurality of acupressure pins retained by the housing cover, each with a first pin end operably coupled to the spring member, each with a second pin end opposing the first pin end and having a rounded pressure surface disposed thereon, each with a pin length separating the first and second pin ends, each with an outer pin length separating the second pin end and the front surface of the housing cover, and each operably configured to translate along a linear pin translation path within the one of the plurality of pin apertures to selectively adjust the outer pin length, the spring member operably configured to bias the plurality of acupressure pins in a longitudinal direction outwardly away from the front surface of the housing cover and the deformable cushion member surrounding the plurality of acupressure pins, and with a perimeter cushion surface, wherein the second pin end of each of the plurality of acupressure pins is operably configured to be interposed between the perimeter cushion surface and the front surface of the housing cover.

13. The ear acupressure assembly according to claim 12, wherein the front surface of the housing cover further comprises:
a front cover area defined by an outer perimeter edge of the housing cover, wherein the plurality of acupressure pins occupy at least 50% of the front cover area and are disposed in a tightly spaced configuration.

14. The ear acupressure assembly according to claim 12, wherein:
the plurality of acupressure pins are each of an elongated shape and have the first pin end thereon directly coupled to the spring member.

15. The ear acupressure assembly according to claim 14, wherein each of the plurality of acupressure pins further comprise:
a flange member disposed proximal to the first pin end thereon and extending radially outward from an outer pin surface thereon.

16. The ear acupressure assembly according to claim 15, wherein:
each of the plurality of pin apertures define a pin aperture diameter and each of the flange members define a flange diameter greater than the pin aperture diameter.

17. The ear acupressure assembly according to claim 12, wherein:
the plurality of acupressure pins are selectively and linearly translatable along the pin length within one of the plurality of pin apertures.

18. The ear acupressure assembly according to claim 12, wherein the sidewall further comprises:
an inner surface defining the housing cavity with a housing volume, the spring member defining a spring volume substantially equal to the housing volume, wherein the spring member is of a polymeric foam material.

19. The ear acupressure assembly according to claim 12, wherein the sidewall further comprises:
an inner surface defining the housing cavity, the spring member directly coupled and retained to the inner surface of the sidewall, the spring member of a polymeric foam material.
